(19) United States
(12) Patent Application Publication
(10) Pub. No.: US 2002/0199044 A1
(43) Pub. Date: Dec. 26, 2002

(54) Method and apparatus for loading a mirror image software copy across circuit cards

(76) Inventor: Joel Futterman, Deltona, FL (US)

Correspondence Address: Siemens Corporation, Intellectual Property Department, 186 Wood Avenue South, Iselin, NJ, 08830, US

(21) Appl. No.: 10/157,436

(22) Filed: May 30, 2002

Related U.S. Application Data
(60) Provisional application No. 60/294,201, filed on May 30, 2001.

(51) Int. Cl. G06F 13/12

(52) U.S. Cl. 710/62

(57) ABSTRACT

The system of this invention is a method and apparatus for servicing processor controlled circuit cards that obviates the need for engineers to maintain comprehensive software file indexes and databases. In the system of this invention, the software and firmware requirements of a replacement circuit card are made by referring to one or more other circuit cards within the equipment rack. One or more other circuit cards within the equipment rack that have appropriate software modules are then located. Copies of the required software modules are then loaded from those cards to the replacement circuit card.

### CROSS REFERENCE TO RELATED APPLICATIONS

This application claims the benefit of priority under 35 U.S.C. 19(e) to copending U.S. Patent Provisional Applications, Serial No. 60/294,201 and filed on May 30, 2001, the contents of said application being incorporated by reference herein in its entirely.

This application is also related to the following U.S. patent applications: U.S. patent application Ser. No. ______ filed May 30, 2002 entitled AN INTEGRATED ACCESS PLATFORM; U.S. patent application Ser. No. ______ filed May 30, 2002 entitled METHOD FOR OPERATING AND APPARATUS FOR A BACK-PLANE SUPPORTING REDUNDANT CIRCUIT CARDS; U.S. patent application Ser. No. ______ filed May 30, 2002 entitled METHOD AND APPARATUS OF TESTING A POTS CIRCUIT AND DSL CIRCUIT THROUGH A SPLITTER; U.S. patent application Ser. No.______ filed May 30, 2002 entitled METHOD AND APPARATUS FOR A COMMON MANAGEMENT SOFTWARE SYSTEM; U.S. patent application Ser. No. ______ filed May 30, 2002 entitled METHOD AND APPARATUS FOR PROVIDING A COMMON TEXT MESSAGING SYSTEM WITHIN A SOFTWARE ARCHITECTURE; U.S. patent application Ser. No. ______ filed May 30, 2002 entitled METHOD AND APPARATUS FOR PROVIDING A STATE MACHINE OPERATING ON A REAL-TIME OPERATING SYSTEM; and U.S. patent application Ser. No. ______ filed May 30, 2002 entitled METHOD AND APPARATUS FOR ADMINISTERING MULTIPLE PROVISIONABLE OBJECTS, the contents of each of said applications being incorporated by reference herein in their entirely.

### FIELD OF THE INVENTION

The present invention relates to telecommunications systems utilizing a plurality of processor controlled circuit cards. More particularly, the present invention relates to methods and apparatus for updating software and/or firmware files of processor controlled circuit cards in such telecommunications systems.

### BACKGROUND OF THE INVENTION

Telecommunications systems, such as the Public Switched Telephone Network, are usually built as large scale centralized networks in which transmission facilities linking customers are interconnected though switching centers. In modem telecommunications installations, each of the interconnecting switching centers or nodes within such a communications network is typically one or more racks or cabinets of digital electronic routing equipment. In order to make the routing equipment both easy to maintain and update, these routing cabinets typically have banks of like circuit cards, each of the like circuit cards performing essentially similar functions.

For instance, a switching rack in a modem telecommunications installation may have fifty or so functionally identical circuit cards, all under the control of one or more rack system controllers. Each of the functionally identical circuit cards, i.e. like circuit cards, may in turn have circuitry for handling a multiplicity of functionally identical tasks, such as a number of telephone connections or data line connections. When a fault is detected on a connection, instead of trying to diagnose the root cause, a maintenance engineer simply replaces the faulty circuit card with a new, like circuit card set up to perform the identical functions of the card it is replacing. Similarly, when improvements to the circuit cards are made, the entire system can be quickly upgraded by an upgrade engineer simply removing old circuit cards and installing new ones.

This system of batches of like circuit cards works well if all such circuit cards are identical or if there are a small number of types of the circuit card or if there are a small number of configuration settings that enable cards to be made functionally identical. However, in modem digital telecommunications switching systems, the individual circuit cards typically have their own software configured microprocessor controlling the multiplicity of elements on them, which typically includes firmware based Application Specific Integrated Circuits (ASIC), Digital Signal Processors (DSP) and volatile Programmable Logic Devices (PLD) elements. Since software and programmable device files are more prone to minor flaws or bugs than hardware, there are numerous versions of each of the control software and device files, each with minor upgrades, bug fixes or patches. The result is effectively a proliferation of versions of circuit cards, each having a slightly different software and device files. Moreover, functionally identical cards in different system racks may need to be configured differently from each other by loading with different software and firmware versions in order to be compatible with other cards in that rack.

As a consequence, maintenance and upgrade engineers' roles are made considerably more difficult. Not only do they need to have spare cards of the right hardware design, they also need to be able to determine the type, the version and the build of software and firmware files required by any card they want to replace. This effectively means their having to know details of every card in the communications system. They must also have access to those specific versions or releases of software and firmware files as well as a way of downloading them to the card. The result is that a typical telecommunications maintenance engineer is now required to carry a laptop containing a comprehensive index of software and firmware file versions in order to diagnose the board's software requirements, as well as a hard drive loaded with all possible versions of software and firmware files that may be required by any circuit card in the entire telecommunications system.

There is clearly a need for a simpler way to maintain and upgrade processor controlled circuit cards and manage the proliferation of software and firmware file versions they require.

### SUMMARY OF THE INVENTION

In view of the above mentioned needs the present invention permits streamlined servicing of processor controlled circuit boards. The first step in achieving this is determining the software and firmware file needs of a replacement board by reference to other circuit cards within the equipment rack. Then other circuit cards within the rack are located having the required software or firmware files, and that required software loaded onto the replacement circuit card.

In one embodiment of the invention, the software requirements of a particular type of circuit card playing a particular role in a telecommunications platform are determined by reference to the platform system controller and its associated databases. The required software, including the generic software code and device files for firmware based ASICs, DSPs and volatile PLD elements on the card, are then retrieved either from a data base attached to the rack or platform controller or from a like processor circuit card having the required software and device files. A file transfer protocol is then initiated in which the platform system controller uploads the required software into a local memory attached to it and then downloads the software to the circuit board requiring it.

In another embodiment of the invention, the required software and device files are stored in flash memory or flash ram so that the software and device files can be transferred more efficiently.

The uploading and downloading are usually done as background tasks while the platform system controller continues to carry out its platform control functions.

### BRIEF DESCRIPTION OF THE DRAWINGS

The foregoing and other objects, features and advantages of the present invention will be more readily appreciated upon reference to the following disclosure when considered in conjunction with the accompanying drawings in which:

FIG. 1 is a schematic diagram of a telecommunications switching system having a plurality of functionally like processor controlled circuit cards;

FIG. 2 is a schematic diagram of a first type of processor controlled circuit card;

FIG. 3 is a schematic diagram of a second type of processor controlled circuit card;

FIG. 4A is a schematic diagram of data flow from a local craft to a system control card;

FIG. 4B is a schematic diagram of data flow from a processor controlled circuit card to a system control card;

FIG. 4C is a schematic diagram of data flow from a system control card to a processor controlled circuit card; and

FIG. 5 is a schematic interface diagram showing the transfer of software and firmware files to the processor controlled circuit card.

### DETAILED DESCRIPTION

During the course of this description like numbers will be used to identify like elements according to the different figures that illustrate the inventions.

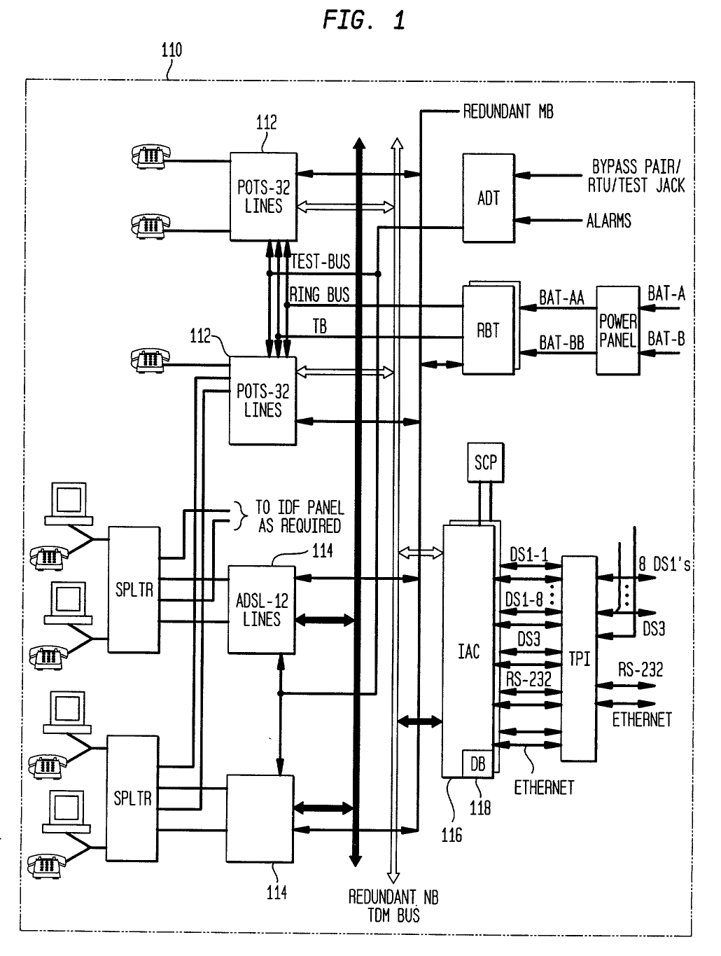

FIG. 1 is a schematic diagram of a telecommunications switching system 110 having a plurality of functionally-like processor-controlled circuit-cards, including a batch of a first type of functionally-like processor-controlled circuit-cards 112 and a batch of a second type of functionally-like processor-controlled circuit-cards 114. The first type of functionally-like processor-controlled circuit-card 112 may for example be, but is not limited to, a Siemens Plain Old Telephone System-32 (POTS32) lines circuit-card. The second type of functionally-like processor-controlled circuit-card 114 may for example be, but is not limited to, a Siemens ADSL-12 lines circuit card. The telecommunications switching system 110 is controlled by a system control card 116, such as for example, but not limited to, a Siemens Integrated Access Control (IAC) card. The system control card 116 includes or has access to a Data Base (DB) 118 that may store software version, build and Cyclic Redundancy Checking (CRC) data. This data is used for labeling and identifying software code and hardware programmable device files required by other circuit cards contained in telecommunications switching system 110. Data Base (DB) 118 may also contain copies or images of the software code and hardware programmable device files required by other circuit cards.

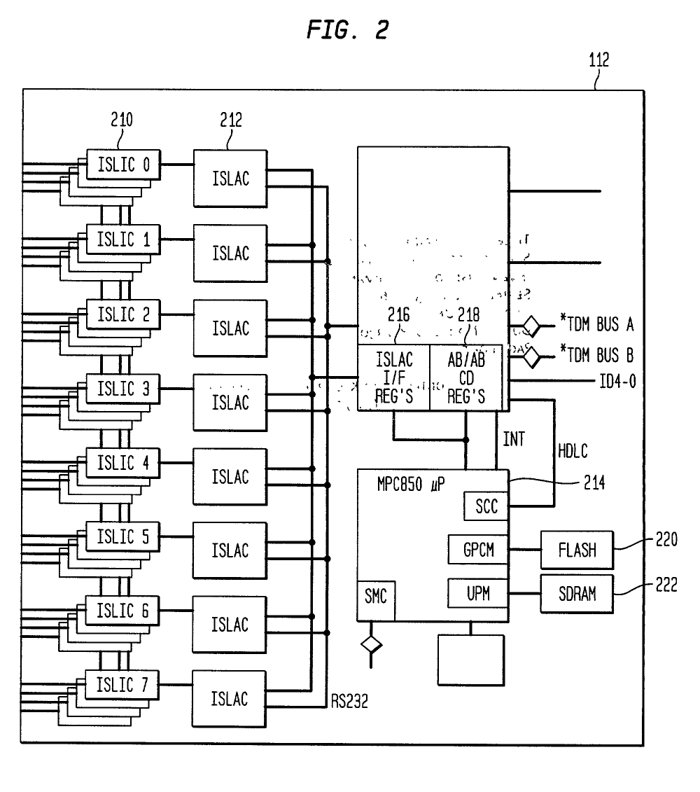

FIG. 2 is a schematic diagram of a first type of processor controlled circuit card 112. These contain a plurality of essentially functionally identical circuit elements that, in the case of a first type of functionally-like processor-controlled circuit-card 112 being a Siemens POTS-32 circuit card, are Subscriber Line Interface Circuits (SLIC) 210 and Subscriber Line Acoustic Circuit (SLAC) 212. In addition this card 112 contains a circuit board control microprocessor 214, Programmable Read Only Memory Based Programmable Logic Device (PROM PLD) 216, Random Access Memory Programmable Logic Device (RAM PLD) 218, FLASH Random Access Memory (RAM) 220 and Dynamic Random Access Memory (DRAM) 222. Circuit board control microprocessor 214, which may for instance be but is not limited to a Motorola processor MPC850, controls the other elements on the board using amongst features the volatile DRAM 222 and non-volatile FLASH RAM 220.

FLASH RAM 220 is an electronically programmable memory that can be erased in blocks rather than bytes for faster updating. FLASH RAM 220 is typically used for storing the circuit board control microprocessor's, 214, control code such as, for instance, the basic input/output system (BIOS), as well as firmware device files used, for instance, in setting up RAM PLD 218. RAM PLD 218 may for instance be, but is not limited to an ALTERA 10K10 and is typically used to control one or more functions of the functionally identical circuit elements on the card, such as but not limited to the control data registers for switching the circuits between redundant system controllers.

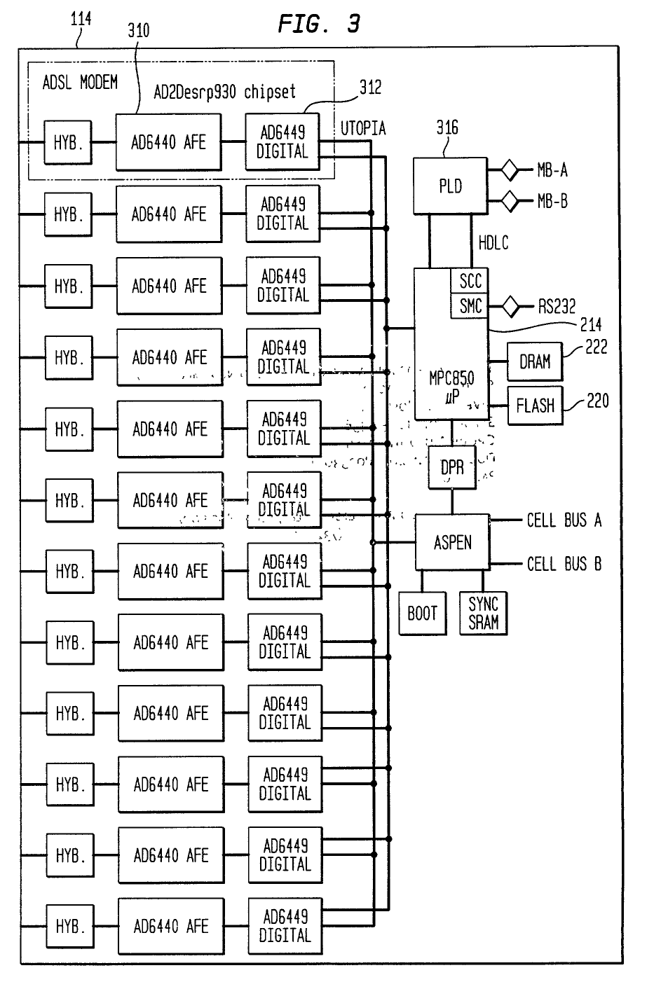

FIG. 3 is a schematic diagram of a second type of functionally-like processor-controlled circuit-card 114. In the case of a second type of functionally-like processor-controlled circuit-card 114 being a Siemens Asymmetric Digital Subscriber Line-12 (ADSL-12) card, it contains a plurality of essentially functionally identical circuit elements such as Analog Device Inc (ADI) chip set AD6440 Analog Front End (AFE) 310 and AD6449 Digital 312. Together these comprise an ADSL Modem 314 that functions as an interface to 12 Tip/Ring pairs of telephone lines. In addition it contains circuit board control microprocessor 214, FLASH RAM 220 and DRAM 222. As in other processor-controlled circuit cards, the circuit board control microprocessor 214, which is for instance, but not limited to, a Motorola processor MPC850, may use the generic software code and device files and other data stored in FLASH RAM 220 to bootstrap its own operation and to set up appropriate functionality in firmware based ASICs, DSPs and volatile PLD elements on the card. For instance, in the case of functionally-like processor-controlled circuit-card 114 being a Siemens Asymmetric Digital Subscriber Line-12 (ADSL-12) card, PLD 316 is setup to act as both a High Level Data Link Control (HDLC) to the system maintenance buses and as an interface to a circuit inventory interface.

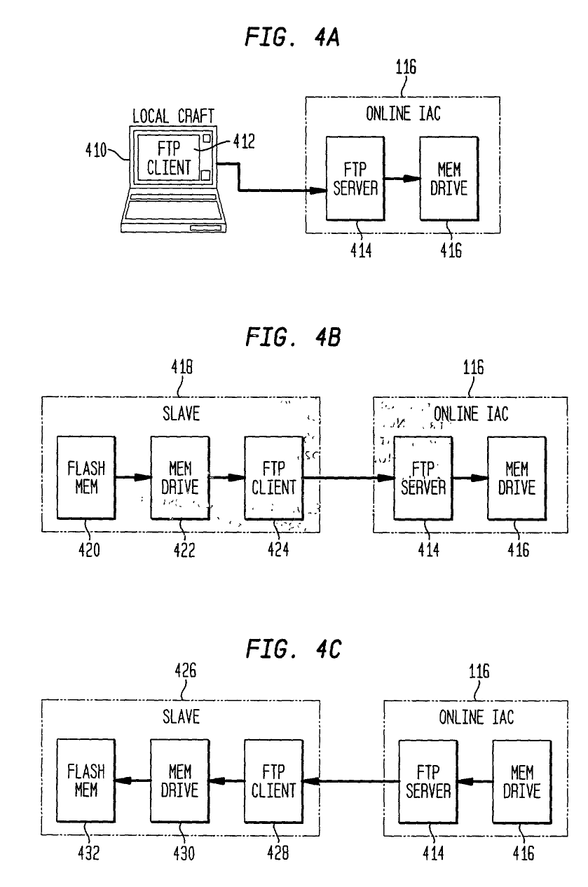

FIG. 4A shows a schematic diagram of data from a local craft, which may be a web-browser 410 on an attached computer to a system control card 116. A maintenance or upgrade engineer may use web-browser 410 to initiate a request to system control card 116 by setting up a File Transfer Protocol (FTP) Client to communicate with an FTP Server 414. The FTP Server 414 communicates with data on the system controller's database 118 using the system control's Memory (Mem) Drive 416. In the situation where the maintenance engineer is replacing an existing card, the data accessed on database 118 may include both information about the required code and database images as well as the required code and database images themselves. This information may include build data, Cyclic Redundancy Check (CRC) data and version data that uniquely identify the software modules required. The code and database images may include software code and programmable device files for firmware based ASICs, DSPs, and volatile PLDs. If the required code and database images, i.e. software modules, are not available on the system control card 116, the information may also include the identification of other sources containing the required software modules, such as other processor-controlled circuit-cards housed in the same rack.

FIG. 4B is a schematic diagram showing the flow of data from a processor controlled circuit card 418 having required software to a system control card 116. Appropriate code and data bases are retrieved from the processor controlled circuit card's, 418, flash memory 420 through the circuit card's memory drive 422 by an FTP client 424 running on the circuit card's control microprocessor. The circuit card's FTP client 424 sends the required data to the system controller's, 116, memory drive 416 through the FTP server 414. This process is sometimes referred to as copying a like processor image to the memory drive and called an upload.

FIG. 4C is a schematic diagram of data flow from a system control card 116 to a processor controlled circuit card 426 requiring software. An FTP server 414 on the system control card 116 retrieves the data stored by the system's memory drive 416 and sends it to a processor controlled circuit card 426 requiring the software. An FTP client 428 receives the data and using memory drive 430 downloads it by writing the data into flash memory 432. This process is sometimes referred to as download.

In the situation where the processor controlled circuit card 418 having required software is functionally identical with the processor controlled circuit card 426 requiring software, the file transfer process may result in a completely identical copy of the information in flash memory 420 being transferred to the flash memory 432. This is sometimes referred to as a mirror image copy of the data being copied across the circuit cards.

An additional embodiment of the invention, not illustrated, causes data transfer to be simultaneously uploaded and downloaded, with fifty percent of the file transfer process being devoted to uploading files and fifty percent devoted to downloading.

The status of the download may be indicated by the FTP server 414 on the web browser 410. This is usually done by a progress window showing the percentage complete and is updated periodically during the download process.

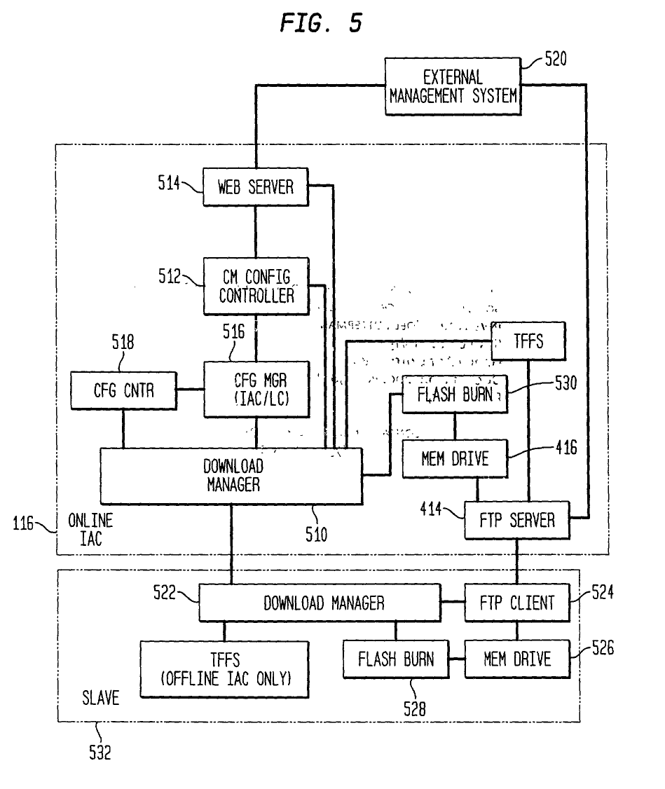

FIG. 5 is a schematic interface diagram showing the interfaces involved in transferring software and firmware files to the processor controlled circuit card. The download manager 510 on the system control card 116 has overall responsibility for controlling the download process and ensuring that it is completed. The Common Management Configuration Controller 512 on the system control card 116 initiates the download request from the maintenance engineer via the web server 514. The configuration manager 516 and configuration controller 518 handle load requests and recover the slave processors, i.e. the processor controlled circuit card 418 having required software and the processor controlled circuit card 426 requiring software, at the end of the download process.

A maintenance engineer using an external management system 520, which may be for instance be a laptop computer, has access to request a download process via either an HTTP interface of the web server 514 or via a TCP/IP interface of the FTP server. A typical request to initiate a download would pass from the web server 514 to the Common Management Configuration Controller 512 and on the system download manager 510.

The system download manager 510 would then send appropriate upload and download requests to the slave card 532 's download manager 522.

In the case of the slave card 532 being processor controlled circuit card 418 having required software, the download manager 522 would request the FTP client 524 to GET data, i.e. obtain data, through the memory drive 526. This data would be transferred through the FTP server 414 on the system control card 116 to memory drive 414 which would use the system controller's flash burn circuitry 530 to transfer and store the data.

In the case of the slave card 532 being processor controlled circuit card 426 requiring software the download manager 522 would request the FTP client 524 to PUT data, i.e. write in FLASH memory the data transferred from the FTP server 414, using memory drive 416. This data is then placed in the slave card 532 using memory drive 526 and the flash burn capability 528.

The result of theses processes is that appropriate bitmaps, i.e. software and firmware data files, required by one processor controlled circuit card 426 can be located by Common Management Configuration Controller 512 on a second processor controlled circuit card 418 in the same system rack. The located bitmaps, or a subset of them after an unsuccessful download, can then be transferred by the download manager 510. In an additional embodiment of the invention this download can be down as a background task. In a further embodiment of the invention the data transfer from FLASH memory 420 to FLASH memory 432 is done by Direct Memory Access (DMA), freeing the microprocessors from direct involvement in the data transfer thus speeding up the overall operation.

While the invention has been described with reference to particular embodiments, it will be appreciated by those of ordinary skill in the art that various modifications can be made to the steps of the method and the apparatus of the invention without departing from the spirit and scope thereof.

We claim:

1. An apparatus for loading one or more software modules to a first processor controlled circuit card requiring said software modules from one or more second processor controlled circuit cards, all said processor controlled circuit cards being housed within a rack, said apparatus comprising:
requirements identification means for determining said software modules required by said first processor controlled circuit card;
fulfillment identification means for identifying said second processor controlled circuit card containing at least one of said software modules required by said first processor controlled circuit card;
upload means for accessing and uploading said software module required by said first processor controlled circuit card from said second processor controlled circuit card; and,
download means for downloading and storing said software module required by said first processor controlled circuit card onto said first processor controlled circuit card.

2. The apparatus of claim 1 wherein said requirements identification means comprises analyzing a system database.

3. The apparatus of claim 2 wherein said fulfillment identification means comprises analyzing a system database.

4. The apparatus of claim 3 wherein said upload means comprises accessing said required software module by direct memory address.

5. The apparatus of claim 4 wherein said download means comprises writing said required software module into a FLASH memory device.

6. The apparatus of claim 5 wherein said requirements identification means comprises analyzing build data, a cyclic redundancy check and version information.

7. A method for loading one or more software modules to a first processor controlled circuit card requiring said software modules from one or more second processor controlled circuit cards, all said processor controlled circuit cards being housed within a rack, said method comprising the steps of:
a. determining said software modules required by said first processor controlled circuit card;
b. identifying said second processor controlled circuit card containing at least one of said software modules determined as being required by said first processor controlled circuit card;
c. accessing said software module required by said first processor controlled circuit card on said second processor controlled circuit card;
d. uploading said software module required by said first processor controlled circuit card from said second processor controlled circuit card;
e. downloading said software module required by said first processor controlled circuit card to said first processor controlled circuit card; and,
f. storing said required software module on said first processor controlled circuit card.

8. The method of claim 7 wherein said determining step (a) includes:
h. the step of analyzing a system database.

9. The method of claim 8 wherein said identifying step (b) includes:
i. the step of analyzing a system database.

10. The method of claim 9 wherein said accessing step (c) includes:
j. the step of accessing said software module by said first processor controlled circuit card by direct memory address.

11. The method of claim 10 wherein said storing step (f) includes:
k. the step of writing said software module by said first processor controlled circuit card into FLASH memory.

12. The method of claim 11 wherein said determining step (a) further includes:
l. the step of verifying said software module by analyzing build data and version data

13. The method of claim 12 wherein said identifying step (b) further includes:
m. the step of verifying said software module by analyzing.
